(19) United States
(12) Patent Application Publication
(10) Pub. No.: US 2025/0124314 A1
(43) Pub. Date: Apr. 17, 2025

(54) META CAUSAL LEARNING OVER MULTIPLE DIRECTED ACYCLIC GRAPHS

(71) Applicant: International Business Machines Corporation, Armonk, NY (US)

(72) Inventors: Songtao Lu, White Plains, NY (US); Tian GAO, Berkeley Heights, NJ (US)

(21) Appl. No.: 18/488,239

(22) Filed: Oct. 17, 2023

(51) Int. Cl. G06N 7/01; G06N 20/00

(52) U.S. Cl. CPC G06N 7/01; G06N 20/00

(57) ABSTRACT

Systems/techniques that facilitate meta causal learning over multiple directed acyclic graphs (DAG) are provided. In various embodiments, a system can structurally decompose multiple DAGs of different domains into a shared DAG with private DAGs for each respective domain. In various aspects, the system can formulate the DAG causal structure learning as a functional constrained bilevel optimization problem. In various instances, the system can implement a bilevel primal dual method that extracts the shared DAG structure while learning the individual DAG model for personalization.

### BACKGROUND

The subject disclosure relates to causal model structure discovery and, more specifically, to meta casual learning over multiple directed acyclic graphs.

### SUMMARY

The following presents a summary to provide a basic understanding of one or more embodiments described herein. This summary is not intended to identify key or critical elements, delineate scope of particular embodiments or scope of claims. Its sole purpose is to present concepts in a simplified form as a prelude to the more detailed description that is presented later. In one or more embodiments described herein, systems, computer-implemented methods, apparatus and/or computer program products that enable meta casual learning over multiple directed acyclic graphs are discussed.

According to an embodiment, a computer-implemented system is provided. The computer-implemented system can comprise a memory that can store computer executable components. The computer-implemented system can further comprise a processor that can execute the computer executable components stored in the memory, wherein the computer executable components can comprise a data gathering component that collects datasets from a plurality of different environments or domains and a decomposition component that acts on the collected datasets to perform structured decomposition on multiple directed acyclic graphs (DAG) into a shared DAG with private DAGs for each environment or domain to generalize DAG learning.

According to another embodiment, a computer-implemented method is provided. The computer-implemented method can comprise collecting, by a system operatively coupled to a processor, datasets from a plurality of different environments or domains and acting, by the system, on the collected datasets to perform structured decomposition on multiple DAGs into a shared DAG with private DAGs for each environment or domain to generalize DAG learning.

According to yet another embodiment, a computer program product for facilitating meta causal learning over multiple directed acyclic graphs is provided. The computer program product can comprise a computer readable storage medium having program instructions embodied therewith, the program instructions executable by a processor to cause the processor to engage a data gathering component that collects datasets from a plurality of different environments or domains and engage a decomposition component that acts on the collected datasets to perform structured decomposition on multiple DAGs into a shared DAG with private DAGs for each environment or domain to generalize DAG learning.

According to one or more embodiments, the above-described systems can be implemented as computer-implemented methods or computer program products.

### BRIEF DESCRIPTION OF THE DRAWINGS

FIG. 1 illustrates a block diagram of an example, non-limiting system that can facilitate meta causal learning over multiple acyclic graphs in accordance with one or more embodiments described herein.

FIG. 2 illustrates a block diagram of an example, non-limiting system that can facilitate meta causal learning over multiple acyclic graphs in accordance with one or more embodiments described herein.

FIG. 3 illustrates a block diagram of an example, non-limiting system that can facilitate meta causal learning over multiple acyclic graphs in accordance with one or more embodiments described herein.

FIG. 4 illustrates a flow diagram of an example, non-limiting computer-implemented method that can facilitate meta causal learning over multiple acyclic graphs in accordance with one or more embodiments described herein.

FIG. 5 illustrates a flow diagram of an example, non-limiting computer-implemented method that can facilitate meta causal learning over multiple acyclic graphs in accordance with one or more embodiments described herein.

FIG. 6 illustrates a flow diagram of an example, non-limiting computer-implemented method that can facilitate meta causal learning over multiple acyclic graphs in accordance with one or more embodiments described herein.

FIG. 7 depicts a plot of the convergence performance of the Meta-DAG alongside other various DAG learning methods in accordance with one or more embodiments described herein.

FIG. 8 depicts a plot of the generalization of the Meta-DAG alongside other various DAG learning methods in accordance with one or more embodiments described herein.

FIG. 9 illustrates a block diagram of an example, non-limiting operating environment in which one or more embodiments described herein can be facilitated.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Causal structure discovery involves inferring underlying causal dependencies or causal relationships within a set of variables or data. When the problem size is large, searching for the exact Bayesian network structure becomes challenging. Causal discovery in the form of directed acyclic graph (DAG) structure learning finds causal relationships among features of sampled data wherein variables are represented by nodes and causal relationships are represented by directed edges. DAG graph structure is acyclic, meaning the graph does not contain loops or cycles (e.g., if an edge connects one node to another node, there is no path that goes from the other node back to the initial node).

Unfortunately, existing techniques for facilitating meta causal learning over multiple DAGs can be unreliable or unsatisfiable for various reasons.

First, causal models generally assume data is independently identically distributed, indicating all data samples are generated by a single underlying causal model. The assumption that variables are generated independently and have the same distribution can lead to inaccurate causal relationship conclusions as in real-world causal systems, variables are often interdependent and may have different distributions. Such an assumption ignores variation of different data features or variables over different domains. That is, data distributions over multiple domains can vary based on personalized attributes in multitask learning problems). For example, in DAG two nodes may have a causal relationship, however, the dependency probabilities or weights among the nodes can vary between respective domains or environments (e.g., one node and a second node may have a causal relationship, however in one domain, the weight is 0.3 and in another domain the weight is 0.45).

Furthermore, existing algorithms implemented to solve a bilevel optimization framework applied to DAG causal structure discovery problems are incapable of satisfying all constraints. In other words, the employed algorithms cannot solve the bilevel optimization problem under the nonlinear, nonconvex functional constraint of DAG structure discovery problems. Such constraint enforces and ensures the graph structure and weight matrix of the resulting solution is able to represent a DAG. Other methods to solve nonlinear or nonconvex functional problems require a regularity condition or feasibility of the initial points to guarantee convergence of the algorithms, however, the DAG constraint does not provide definitive indication that such conditions will be satisfied.

Various embodiments of the present disclosure can be implemented to produce a solution to these problems. Embodiments described herein include systems, computer-implemented methods, and computer program products that can facilitate meta causal learning over multiple DAGs.

Various embodiments described herein can address one or more of these technical problems. One or more embodiments described herein can include systems, computer-implemented methods, apparatus, or computer program products that can facilitate meta causal learning over multiple acyclic graphs. That is, the present inventors realized that various disadvantages associated with existing techniques for causal model structure discovery can be ameliorated by meta causal learning over multiple acyclic graphs.

In various aspects, a matrix W∈ [symbol] ^{d×d} is considered a DAG if it satisfies the constraint defined by Equation 1.
Equation 1: h(W)=tr(e^{W∘W)}−d=0, where d denotes the problem dimension (e.g., size of the DAG), the operator ∘ denotes the Hadamard product, and e^{W} is a representation of the matrix exponential of W.

In various embodiments, the data gathering component can collect datasets from a multitude of different domains or environments. In various aspects, the decomposition component can act on the collected datasets to perform structured decomposition on multiple DAGs into a shared DAG with private DAGs for each environment or domain to generalize DAG learning, and wherein the data is not necessarily independently and identically distributed. In various embodiments, the analysis component can formulate the DAG causal structure discovery problem as a functional constrained bilevel optimization problem. Furthermore, the analysis component can employ a bilevel primal dual method to solve the bilevel optimization problem with guaranteed convergence solutions. In various aspects, the bilevel optimization framework can improve generality of the model. For instance, such DAG learning framework can apply to a wide range of hierarchal constrained learning systems (e.g., learning models under multiple constraints, meta learning under functional constraints, meta-actor critic schemes in safe reinforcement learning). Furthermore, the meta-DAG model can be applied to solving nonlinear DAG structures in addition to linear DAG structures. In various embodiments, the meta-DAG model provides improved interpretability by providing causal relationships among factors across multiple domains. Moreover, the meta-DAG method is theoretically grounded. More specifically, the bilevel primal dual algorithm can find the Karush-Kuhn-Tucker points with theoretical convergence rates guaranteed. The bilevel optimization framework with a bilevel primal dual method further enables scalability of the Meta-DAG model by outperforming other DAG causal learning models when the problem size is large.

It should be appreciated that the herein figures and descriptions provide non-limiting examples of various embodiments and are not necessarily drawn to scale.

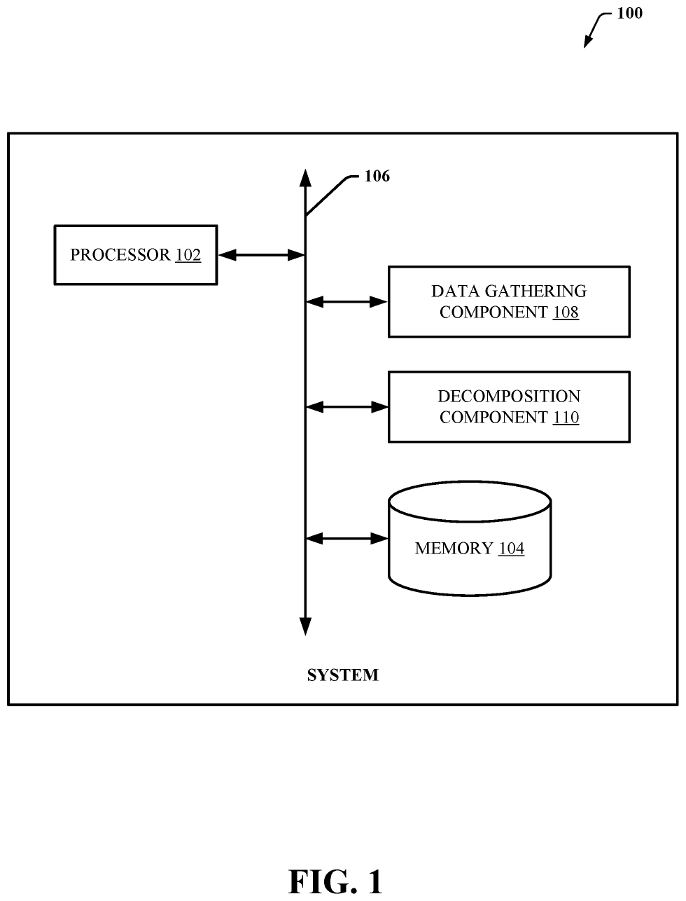

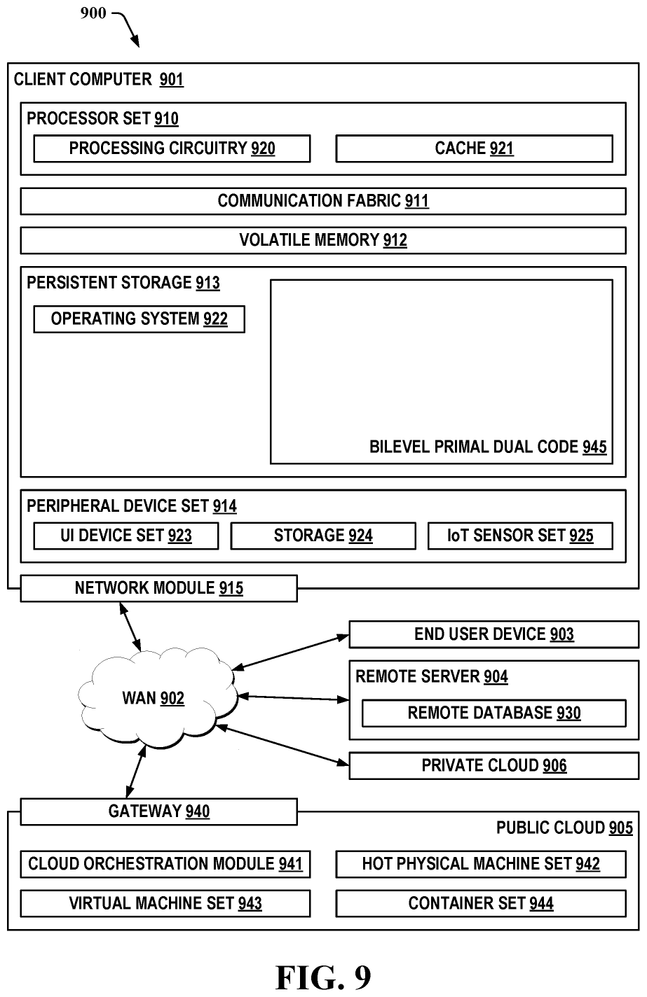

The embodiments depicted in one or more figures described herein are for illustration only, and as such, the architecture of embodiments is not limited to the systems, devices and/or components depicted therein, nor to any particular order, connection and/or coupling of systems, devices and/or components depicted therein. For example, in one or more embodiments, the non-limiting systems described herein, such as non-limiting system 100 as illustrated in FIG. 1, and/or systems thereof, can further comprise, be associated with and/or be coupled to one or more computer and/or computing-based elements described herein with reference to an operating environment, such as the operating environment 900 illustrated at FIG. 9. For example, system 100 can be associated with, such as accessible via, a computing in environment 900 described below with reference to FIG. 9, such that aspects of processing can be distributed between system 100 and the computing environment 900. In one or more described embodiments, computer and/or computing-based elements can be used in connection with implementing one or more of the systems, devices, components and/or computer-implemented operations shown and/or described in connection with FIG. 1 and/or with other figures described herein.

FIG. 1 illustrates a block diagram of an example, non-limiting system 100 that facilitates meta causal learning over multiple acyclic graphs in accordance with one or more embodiments described herein. System 100 can comprise processor 102, memory 104, system bus 106, data gathering component 108, and decomposition component 110.

The system 100 and/or the components of the system 100 can be employed to use hardware and/or software to solve problems that are highly technical in nature (e.g., related to meta-learning, bilevel optimization, DAG causal structure discovery, etc.), that are not abstract and that cannot be performed as a set of mental acts by a human. Further, some of the processes performed may be performed by specialized computers for carrying out defined tasks related to causal model structure discovery. The system 100 and/or components of the system can be employed to solve new problems that arise through advancements in technologies mentioned above, functional constrained bilevel optimization, and/or the like. The system 100 can provide technical improvements to causal model structure discovery by improving generalization performance of structure learning, providing guaranteed theoretical convergence rates, and/or improve efficiency of recovering the ground truth of causal models, etc.

Discussion turns briefly to processor 102, memory 104 and bus 106 of system 100. For example, in one or more embodiments, the system 100 can comprise processor 102 (e.g., computer processing unit, microprocessor, classical processor, and/or like processor). In one or more embodiments, a component associated with system 100, as described herein with or without reference to the one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., data gathering component 108, decomposition component 110) to perform one or more actions. In one or more embodiments, memory 104 can store computer-executable components (e.g., data gathering component 108, decomposition component 110).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s).

In various embodiments, the system 100 can comprise a data gathering component 108 that can collect datasets from a plurality of different environments or domains. For example, in various applications (e.g., DNA discovery, molecular structure, patient treatment effects), the model can utilize a plurality of domains wherein each domain represents a unique set of characteristics (e.g., population demographic, chemical class or compound, individual patient) to enhance generality of discovery of the underlying causal model. That is, different nodes in a causal structure may have dependencies or causal relationships among themselves, however, the strength of such dependencies can vary among each node. For example, in applications of determining treatment effects on patients, the model can treat each patient (e.g., group of patients) as a separate domain because each patient can have different reactions to a treatment. Thus, a shared common causal factor of treatment effects can be learned while acknowledging the difference in individual traits of the respective patients or domains. Furthermore, the gathered datasets can comprise training domains and testing domains for training and testing the meta causal learning model.

In various embodiments, the system 100 can comprise a decomposition component 110 that can act on the collected datasets gathered by the data gathering component 108 to perform structured decomposition on multiple DAGs into a shared DAG with private DAGs for each environment or domain to generalize DAG learning.

In various aspects, the decomposition component 110 can utilize multiple non-independently and identically distributed structural equation models (SEM) represented by Equation 2 to model the shared DAG and the private DAGs of each environment or domain to uncover the ground truth of the underlying causal structure.
Equation 2: xᵢⱼ=(W_{S}∘W_{P,i})xᵢⱼ+Eᵢⱼ, ∀i∈[m], j∈[n], where m is the number of environments or domains, n is the number of data samples, W_{S} is a representation of the shared DAG matrix, W_{P,i} is a representation of the private DAG weight matrix corresponding to the ith environment, and Xᵢⱼ=[xᵢ₁, . . . , xᵢⱼ, . . . , xᵢₙ]∈ [symbol] ^{d×n}. Furthermore, Eᵢⱼ∈ [symbol] denotes the noise vector observed at the jth data sample in the ith environment, and xᵢⱼ∈ [symbol] denotes the jth data collected from the ith domain.

In various embodiments, the shared DAG matrix and private DAG matrices are coupled together using a Hadamard product (e.g., element-wise multiplication). The Hadamard product of matrices is a binary operation that multiplies corresponding elements of two matrices of the same size to produce a new matrix of the same dimensions. Each element in the resulting matrix is obtained by multiplying the respective elements in the original matrices. In this case, each private DAG weight matrix is coupled to the shared DAG matrix using the Hadamard product.

Utilizing a private DAG for each domain enables the model to learn the respective data distributions for each domain or environment. In various aspects, the shared DAG characterizes the causal relationships among factors or variables across domains and the private DAGs quantify the corresponding strengths of the factors. More specifically, the shared DAG matrix represents the connectivity of nodes (e.g., data features or variables) over all domains d and the private DAG weight matrix contains the weights or probabilities of the node causal relationship for its respective domain. In various aspects, by employing the model, heterogeneity within data distributions can be mitigated and allow the shared DAG matrix to leverage a wider range of data. Furthermore, leveraging wider ranges of data can enable the model to enhance or remain capable of generating an accurate causal structure when data may be inconsistent, incomplete, or limited (e.g., data is missing values). In various instances, if a domain has limited data samples, the decomposition component 110 can utilize similar or related domains to the domain with limited data. Thus, causal relationships of the domain can still be accurately discovered.

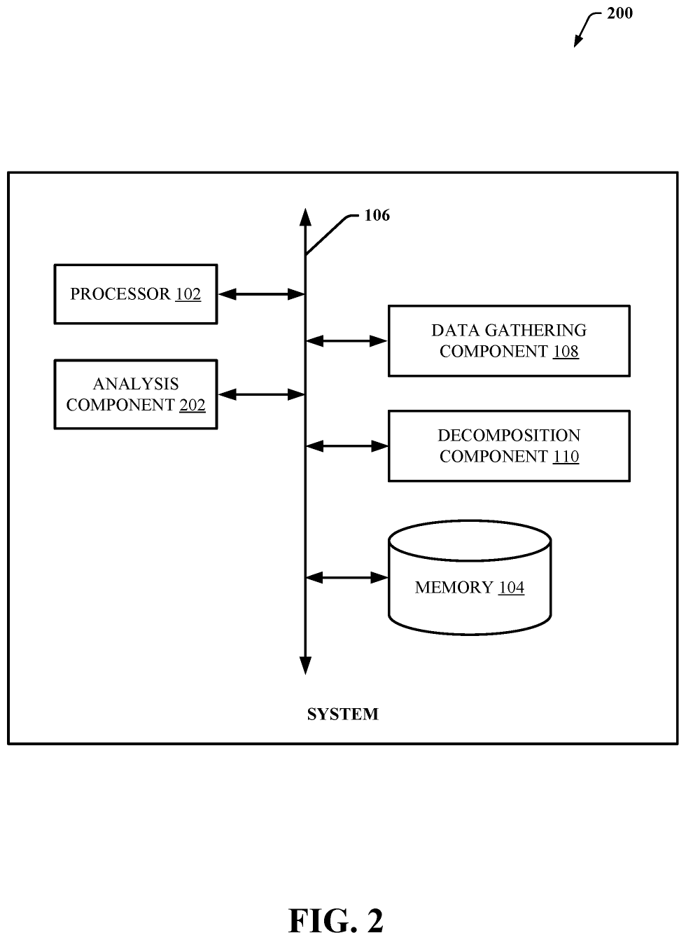

FIG. 2 illustrates a block diagram of an example, non-limiting system 200 that facilitates in accordance with one or more embodiments described herein. As shown, the system 200 can, in some cases, comprise the same components as the system 100, and can further comprise an analysis component 202.

In various aspects, as described herein, the analysis component 202 can formulate and solve a functional constrained bilevel optimization problem for uncovering the underlying causal structure of the data. The functional constrained bilevel optimization model for meta-DAG (e.g., the shared DAG structure and the private DAG weights) learning can be formulated by Equation 3.

$${min}_{{w}_{s}} \frac{1}{m} {\sum }_{i = 1}^{m} {f}_{i} ( {W}_{S} , {W}_{P , i}^{⋆} ( {W}_{S} ) ) + η {‖ {W}_{S} ‖}_{1} , \text{} such that {W}_{P , i}^{⋆} ( {W}_{S} ) = arg {min}_{{w}_{P , i}} \frac{1}{2 n} {‖ {X}_{i} - ( {W}_{S} ∘ {W}_{P , i} ) {X}_{i} ‖}_{2}^{2} , ∀ i , and h ( {W}_{S} ) = 0 , \qquad Equation 3$$

and where ∥W_{S}∥₁ denotes the sparsity regularity term (e.g., mathematical expression or penalty added to the loss function during training to encourage sparsity in the model's parameters or representations), W_{P,i}^{*}(W_{S}) is the optimal solution of the ith lower-level problem, η>0 represents the penalty parameter (e.g., parameter to control the sparsity of the model to prevent overfitting and control model complexity), and the functional constraint h(W) defined in Equation 1 imposes the DAG graph structure on the causal relations among the features. Furthermore, ƒᵢ(⋅) represents the loss function (e.g., score function) of the ith task, modeled by Equation 4.

$${f}_{i} ( {W}_{S} , {W}_{P , i}^{⋆} ( {W}_{s} ) ) {=}^{△} \frac{1}{2 n} {‖ {X}_{i} - ( {W}_{S} ∘ {W}_{P , i}^{⋆} ( {W}_{S} ) ) {X}_{i} ‖}_{2}^{2} \qquad Equation 4$$

In various embodiments, the bilevel optimization model comprises an upper level and lower level, separating the learning of the DAG structure and weights into two parts (e.g., the shared DAG and the private DAGs). In the upper level, the shared DAG structure is extracted over the m domains. In the lower level, the private DAG structure can be extracted for the individual domain. That is, for each domain and given the shared DAG matrix, the analysis component 202 can extract the private DAG weight matrix under the DAG constraint. Moreover, the analysis component 202 can execute the upper-level objectives and optimization in the upper level and execute the lower-level objectives and optimization in the lower level. Extraction of the shared and private DAGs by the analysis component 202 is executed while satisfying the DAG constraint h(W_{S}) to ensure the resulting solution is a DAG graph structure and not an arbitrary matrix. In various embodiments, the bilevel optimization framework of the meta-DAG model enables the model to harness large volumes of data samples to extract the shared DAG structure with minimal variance while adjusting to the unique data distributions of each data source to prevent interference across domains.

Furthermore, for each loss function ƒᵢ(⋅) of the upper level, there is another optimization problem of the lower level. The loss functions are minimized for each domain over the private DAG weight matrix of the respective domain under the functional DAG constraint.

In various embodiments, the formulation of the meta-DAG structure can be generalized and concisely formulated into Equation 5 to be applied to solve other bilevel optimization continuous constraint problems.

$${min}_{x} \frac{1}{m} {\sum }_{i = 1}^{m} {f}_{i} ( x , {y}_{i}^{⋆} ( x ) ) + η r ( x ) such that {y}_{i}^{⋆} ( x ) = arg {min}_{{y}_{i}} {g}_{i} ( x , {y}_{i} ) , ∀ i , and h ( x ) = 0 , where r ( \cdot ) ( e . g . , {‖ \cdot ‖}_{1} ) \qquad Equation 5$$

is (nondifferentiable) convex with proximal mapping or projection onto ∂r(⋅). For simplicity of notations, x represents W_{S}, and yᵢ represents W_{P,i}.

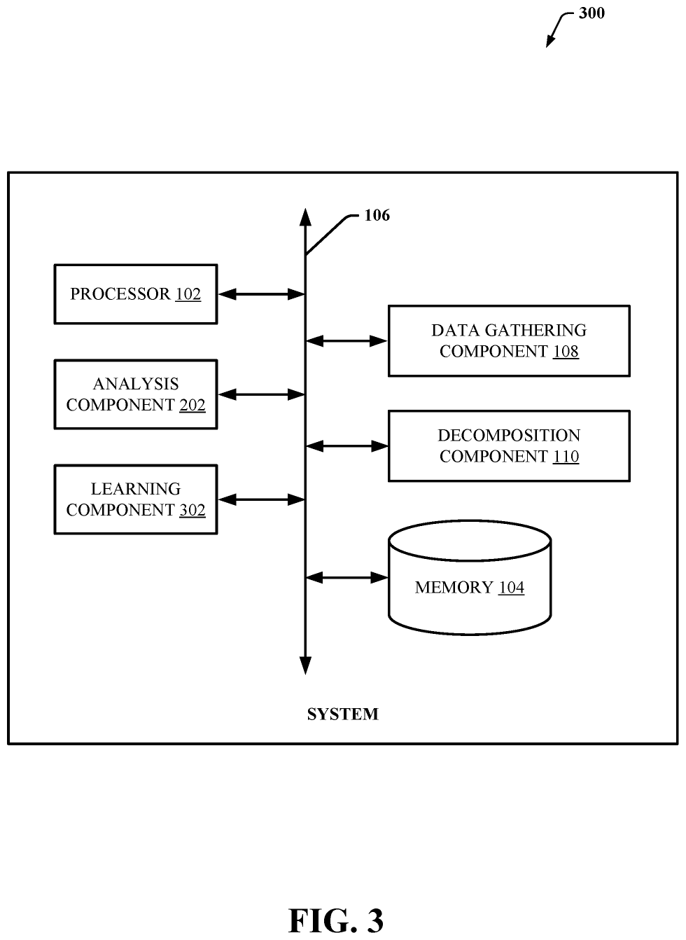

FIG. 3 illustrates a block diagram of an example, non-limiting system 300 that facilitates in accordance with one or more embodiments described herein. As shown, the system 300 can, in some cases, comprise the same components as the system 200, and can further comprise a learning component 302.

In various embodiments, the analysis component 202 can engage the learning component 302 to execute learning of the shared DAG and private DAGs from the SEMs using a bilevel primal dual (BPD) algorithm. In various aspects, the BPD algorithm comprises four steps of updates that are executed in a single loop. In other words, the algorithm updates the model step-by-step and does not require execution of subroutines. Thus, the simplicity of the algorithm can enable efficient and easy implementation of the meta-DAG system. The BPD algorithm is utilized to balance loss minimization and functional constraint enforcement in DAG learning.

In various aspects, the learning component 302 can employ a perturbed linearized augmented Lagrangian (AL) method in the BDP algorithm, modeled by Equation 6.

$${L}_{{ρ}_{t}} ( x , λ ) = F ( x ) + ( 1 - ϱ ) λ h ( x ) + \frac{{ρ}_{t}}{2} {h}^{2} ( x ) , \text{} where F ( x ) {=}^{△} {m}^{- 1} {\sum }_{i = 1}^{m} {F}_{i} ( x ) , {F}_{i} ( x ) {=}^{△} {f}_{i} ( x , {y}_{i}^{⋆} ( x ) ) , \qquad Equation 6$$

λ denotes a dual variable that causes the non-linear constraint h(x)=0 to be satisfied, ϑ∈(0, 1) is a perturbation (e.g., dampen) constant, and ρₜ>0 is a dynamic penalty sequence indexed by iteration t. Furthermore, because ƒₒ(⋅,⋅) is a function of yᵢ^{*}(x), the chain rule is utilized to compute the implicit gradient of the upper-level loss function. Moreover, if gᵢ(,), ∀i is strongly convex, a closed form upper-level gradient expression can be derived. By replacing yᵢ^{*}(x) by yᵢ, a gradient estimate of the AL can be modeled by

$$∇ ( x , y , λ ) {=}^{△} ( ( 1 - ϱ ) λ + {ρ}_{t} h ( x ) ) ∇ h ( x ) + \frac{1}{m} {\sum }_{i = 1}^{m} {∇}_{X} {f}_{i} ( x , {y}_{i} ) - {∇}_{{xy}_{i}}^{2} {{g}_{i} ( x , {y}_{i} ) [ {∇}_{{y}_{i} {y}_{i}}^{2} {g}_{i} ( x , {y}_{i} ) ]}^{- 1} {∇}_{{y}_{i}} {f}_{i} ( x , {y}_{i} ) , where y denotes {y}_{i} , … , {y}_{m} .$$

In various aspects, implementation of the AL can enhance convergence behavior. through utilization of damping parameters (e.g., (1−ϑ)) that support stabilization of convergence of the algorithm by optimizing the shared DAG structure.

In various embodiments, the learning component 302 can engage execute the BPD algorithm to solve the bilevel optimization problem described in equation 5. The BPD algorithm first executes local task adaptation at the lower level by minimizing optimization of lower-level objectives with respect to x (e.g., the shared DAG matrix). In various aspects, the learning component 302 can employ any suitable gradient descent algorithm (e.g., classic gradient descent, stochastic gradient descent) to perform local task adaptation over the corresponding domain data. Performing such local task adaptation in the lower level can contribute to enhanced generalization performance of the causal model. The local task adaptation can be formulated by Equation 7.

$$Equation 7$$

$${y}_{i}^{t + 1} = {y}_{i}^{t} - {β}_{t} ∇ {g}_{i} ( {x}^{t} , {y}_{i}^{t} ) , where {β}_{t} denotes the step size .$$

After, the BPD algorithm acts on what is learned in the lower level to perform sparse learning on the upper-level objectives. The BPD algorithm uses sparse learning to consider prior knowledge into the learning of the DAG structures. In various aspects, the BPD algorithm executes sparse learning or proximal updates of upper-level optimization with respect to x (e.g., the shared DAG matrix) based on the gradients of the upper-level objectives evaluated at the current shared DAG matrix and what is learned from the private DAG matrices in the lower-level processes. The sparse learning executed in the BPD algorithm can be formulated by Equation 8.

$$Equation 8$$

$${\hat{x}}^{t} = arg {min}_{x} 〈 ∇ ( {x}^{t} , {y}^{t} ) , x - {x}^{t} 〉 + η r ( x ) + \frac{{τ}_{t}}{2} {‖ x - {x}^{t} ‖}^{2}$$

where τₜ>0 is an increasing sequence.
As the upper-level objective function includes the non-smooth term, the learning component 302 utilizes a successive convex approximation method to handle the upper-level optimization problem. More specifically. the learning component 302 can linearize the perturbed AL at x^{t} as a surrogate function (e.g., a function that approximates another function) and uses its gradient estimate to obtain a one-step update of variable x followed by a convex combination of the most updated variable and the previous one. Furthermore, the objective function in the x sub-problem is quadratic, and thus a closed-form expression of the update of x-update can be defined by the following equation:

$${\hat{x}}^{t} = {prox}_{η r} ( {x}^{t} - \frac{1}{{τ}_{t}} ∇ \tilde{{L}_{{ρ}_{t}}} ( {x}^{t} , {y}^{t} , {λ}^{t} ) ) ,$$

where prox_{ηr}(⋅) represents the proximal operator and τₜ⁻¹ denotes the step size of the x-update.

After sparse learning has been executed, the BPD algorithm can execute a single step of dampening to stabilize convergence of the algorithm, formulated by Equation 9.

$${x}^{t + 1} = ( 1 - α ) {x}^{t} + α {\hat{x}}^{t} , where α ∈ ( 0 , 1 ) . \qquad Equation 9$$

In various aspects, utilization, by the BPD algorithm, of gradient descent and perturbed descent can enhance efficiency of the algorithm.

Once the previous updates have been made, the BPD algorithm can enforce the DAG constraint through a dual update. The update of the dual variable is formulated by Equation 10.
Equation 10: λ^{t+1}=(1−ϑ)λ^{t}+ρₜh(x^{t+1}), where ρₜ>0 serves the step size of the dual variable update.

In various aspects, the BPD algorithm uses the following assumptions. Assumption 1: (Lipschitz continuity) Functions ƒᵢ(⋅), gᵢ(⋅) are smooth, ∇ƒᵢ(⋅), ∇gᵢ(⋅), ∇²gᵢ(⋅), are Lipschitz continuous with constants L_{ƒ,1}, L_{g,1}, L_{g,2} for both x and yᵢ, ∀i, function h(⋅) is smooth and bounded by Uₕ, and ∇h(⋅) is Lipschitz continuous with constant Lₕ. Assumption 2: (Strong convexity of gᵢ(⋅) with respect to yᵢ) Function gᵢ(⋅), ∀i are u-strongly convex with respect to yᵢ.

Given Assumption 1 and Assumption 2, the following theorem can be applied. Theorem 1: Suppose that Assumption 1 and Assumption 2 hold. When step-sizes are chosen as τₜ˜ρₜ˜ [symbol] (t^{1/3}), βₜ˜ [symbol] (1/t^{1/3}), then the iterates {x^{t},y^{t},λ^{t},∀i,t} generated by BPD can obtain Karush-Kuhn-Tucker (KKT) points of the defined problem at a rate of

$$𝒪 ( 1 / {T}^{\frac{2}{3}} ) ,$$

where T denotes the total number of iterations. Theorem 1 quantifies the number of iterations required to achieve the e-approximate KKT points of Equation 4 (including both the first-order stationarity of the solutions and the constraints violation) to be on the order of 1/ϵ³, matching the standard rate of solving only single-level nonconvex functional constrained problems.

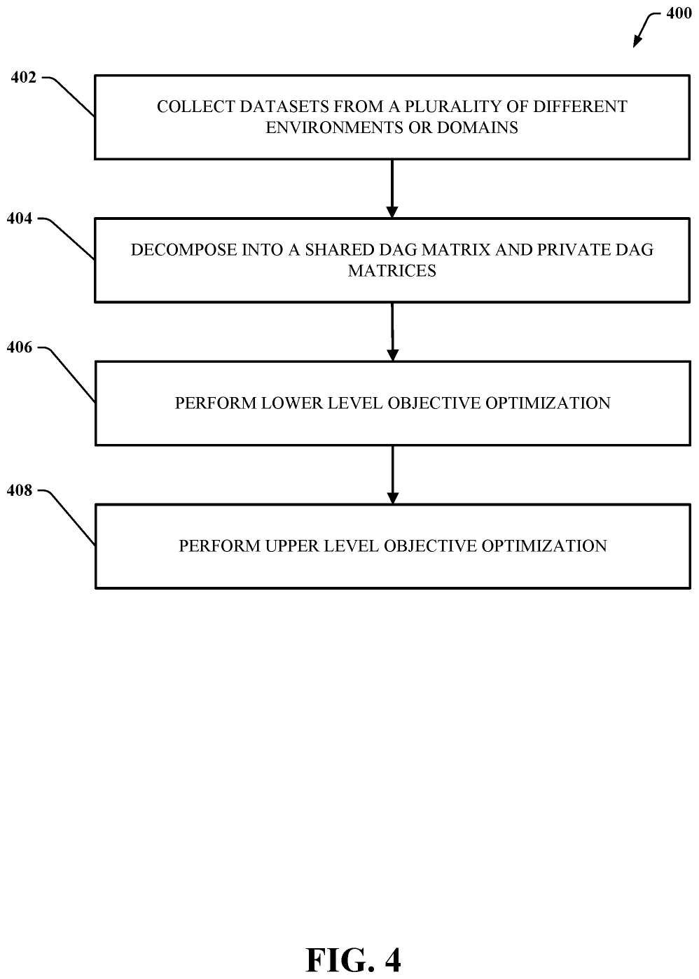

FIG. 4 illustrates a flow diagram of an example, non-limiting method 400 that can facilitate meta causal learning over multiple DAGs in accordance with one or more embodiments described herein. Repetitive description of like elements and/or processes employed in respective embodiments is omitted for sake of brevity.

At 402, the non-limiting method 400 can comprise collecting (e.g., by the data gathering component 108), by the system, datasets from a plurality of different environments or domains.

At 404, the non-limiting method 400 can comprise decomposing (e.g., by the decomposition component 110), by the system, the collected datasets into a shared DAG matrix and private DAG matrices for each domain.

At 406, the non-limiting method 400 can comprise performing (e.g., by the analysis component 202), by the system, lower-level objective optimization for each domain.

At 408, the non-limiting method 400 can comprise performing (e.g., by the analysis component 202), by the system, upper-level objective optimization on the shared DAG matrix.

For example, the data gathering component 108 can collect datasets from m=3 domains with a variable size (e.g., DAG size) d, wherein each domain is an individual patient. The decomposition component 110 can structurally decompose the data into a shared DAG matrix that indicates the causal relationships of the variables, and private DAG weight matrices representing each patient that quantifies the causal relationships of the variables. In the upper level of the bilevel optimization problem, the BPD algorithm optimizes the upper-level loss function over optimization variable x (e.g., shared DAG). In the lower level, the BPD algorithm minimizes an individual loss function of the respective domain for each upper-level loss function over optimization variable yᵢ (e.g., the private DAG matrices representative of each patient).

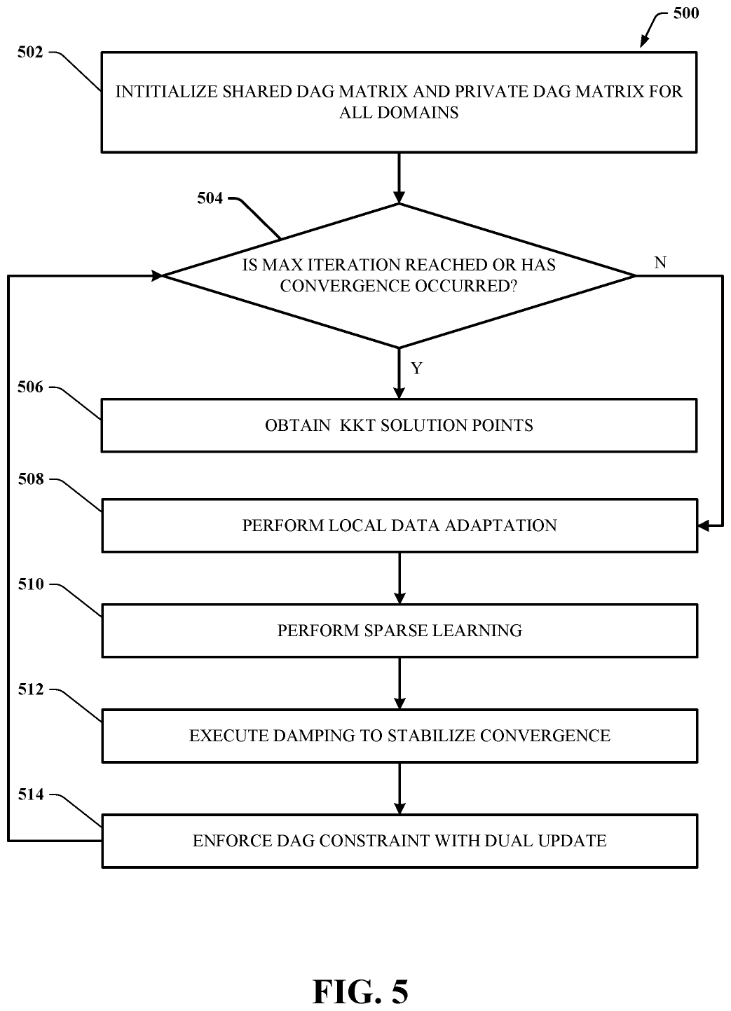

FIG. 5 illustrates a flow diagram of an example, non-limiting method 500 that can facilitate meta causal learning over multiple DAGs using a BPD algorithm in accordance with one or more embodiments described herein.

At 502, the non-limiting method 500 can comprise initializing (e.g., by the learning component 302), by the system, the shared DAG matrix and private DAG matrices for each domain.

At 504, the non-limiting method 500 can determine if the maximum iteration has been reached or if the algorithm has converged. If yes, the non-limiting method 500 can obtain, at 506, the KKT solution points If no, the non-limiting method 400 can proceed to 408.

At 508, the non-limiting method 500 can comprise performing (e.g., by the learning component 302), by the system, local data adaptation for each private DAG matrix for all domains in the lower level.

At 510, the non-limiting method 500 can comprise performing (e.g., by the learning component 302), by the system, sparse learning in the upper level to include prior knowledge into learning of the causal model.

At 512 the non-limiting method 500 can comprise executing (e.g., by the learning component 302), by the system, damping to stabilize convergence of the BPD algorithm.

At 514, the non-limiting method 500 can comprise enforcing (e.g., by the learning component 302), by the system, the DAG constraint using dual update on the dual variable.

In various aspects, the BPD algorithm described can be adapted to the linear Meta-DAG model. The adapted BPD algorithm for linear Meta-DAG acts on data Xᵢ, i∈[m], where m is the number of domains or environments and Xᵢ is the dataset of the ith domain. The adapted BPD algorithm first comprises initializing W_{S} and W_{P,i}, ∀i, where W_{P} [symbol] (W_{P,1}, . . . , W_{P,m}). In each iteration of the single loop updates, while the algorithm has not converged and the maximum iteration has not been reached, the learning component 302 can first perform local task adaptation modeled by the following equation: W_{P,i}^{t+1}=W_{P,i}^{t}−βₜ∇gᵢ(W_{S}^{t},W_{P,i}^{t}), ∀i. After, sparse learning using soft thresholding can be executed and is formulated by the following equation:

$${\hat{W}}^{t} = soft ( {W}_{S}^{t} - \frac{1}{{τ}_{t}} ∇ ( {W}_{S}^{t} , {W}_{P}^{t} , {λ}^{t} ) , η ) .$$

Then, the learning component 302 can execute stabilization with one dampen step, formulated by the following equation: W_{S}^{t+1}=(1−α)W_{S}^{t}+αŴ^{t}. Next, the learning component 302 can execute a dual update on the dual variable, formulated by the following equation: λ^{t+1}=(1−ϑ)λ^{t}+ρₜh(W_{S}^{t+1}). After an iteration of the four updates is executed, the BPD algorithm can iterate again if the algorithm has not converged, and the maximum iteration has not been reached.

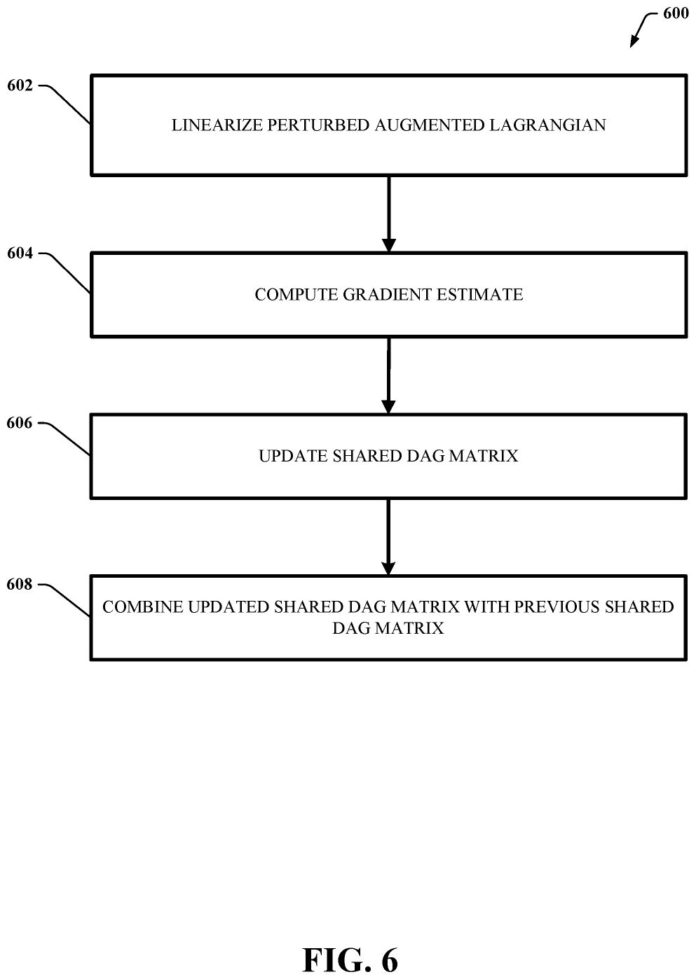

FIG. 6 illustrates a flow diagram of an example, non-limiting method 600 that can facilitate meta causal learning over multiple DAGs using a BPD algorithm in accordance with one or more embodiments described herein.

At 602, the non-limiting method 600 can comprise linearizing (e.g., by the learning component 302), by the system, the perturbed augmented Lagrangian at x^{t} as a surrogate function.

At 606, the non-limiting method 600 can comprise linearizing (e.g., by the analysis component 202), by the system, computing the gradient estimate to obtain a one-step update of.

At 608, the non-limiting method 600 can comprise updating (e.g., by the learning component 302), by the system, the shared DAG matrix.

At 602, the non-limiting method 600 can comprise combining (e.g., by the learning component 302), by the system, the updated shared matrix with the previous shared DAG matrix.

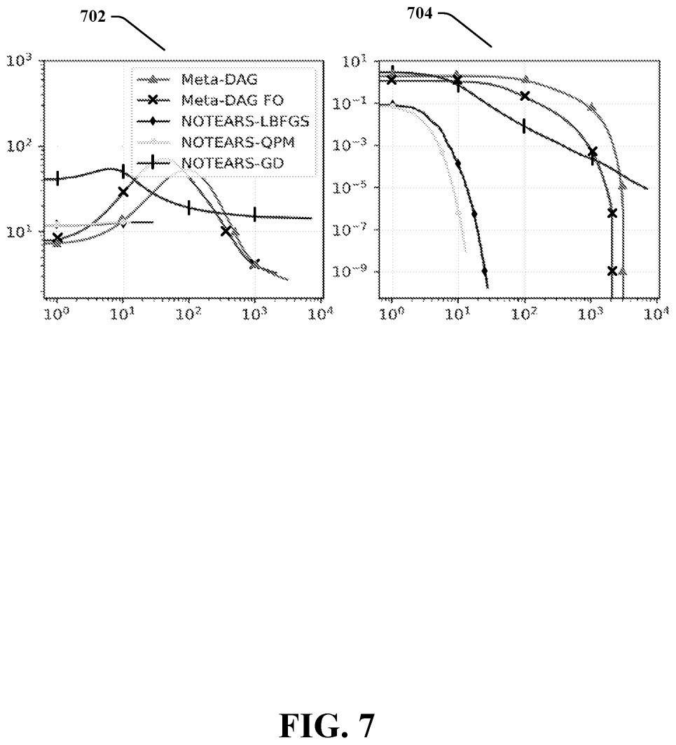

FIG. 7 is a plot of the convergence performance of the Meta-DAG alongside other various DAG learning methods in accordance with one or more embodiments described herein.

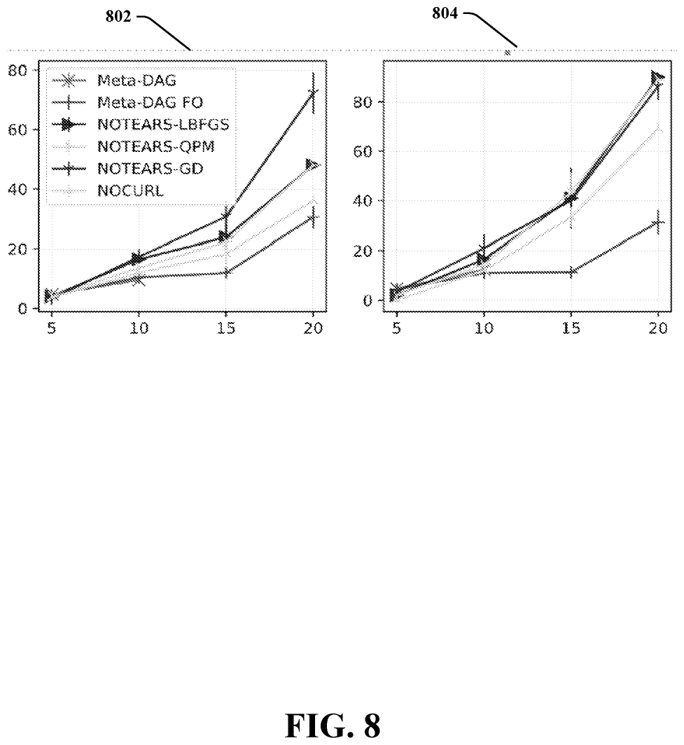

Referencing FIG. 7 and FIG. 8, the other DAG learning models include four closely related optimization-based baselines to the Meta-DAG algorithm (e.g., Meta-DAG-FO (first-order), NOTEARS-LBFGS (limited-memory Broyden-Fletcher-Goldfarb-Shanno), NOTEARS-QPM (quadratic penalty method), NOTEARS-GD (gradient descent)). Furthermore, random Erdös-Rényi graphs with degree two and variable size d are generated, and uniform random weights W_{S} and multiple W_{P,i}, corresponding to different problem domains, are generated. The data Xᵢ∈ [symbol] ^{n×d} is then generated by taking n i.i.d. samples from the linear SEM, where z is a Gumbel noise to ensure identifiability. Three datasets were generated with different W_{P,i}'s for variable size d=5, 10, 15, and 20. Each dataset contains m=3 training domains and 1 test domain with a sample size of n=100. A standard structural Hamming distance (SHD) and standard deviation across different dataset, with respect to the true graph as the accuracy measure for the DAG structure learning task, is used as an evaluation metric.

Plot 702 and plot 704 shows the training loss and constraint value of different algorithms for the first run of d=10 case, respectively. In plot 702, training objective values of the DAG learning models versus the training iterations are plotted to observe convergence performance. In plot 704, the constraint h(W_{S}) value versus the training iterations are plotted. In various aspects, observed in plot 702, the Meta-DAG algorithm can attain lower training objectives than the other DAG learning models, including Meta-DAG-FO. Observed in plot 704, both Meta-DAG models (e.g., full Meta-DAG and first-order Meta-DAG) converge to the zero-constraint value, although META-DAG-FO has a slightly faster convergence speed. Thus, with additional consideration of the memory and computation efficiency, FO Meta-DAG can only be evaluated for larger d's.

FIG. 8 is a plot of the generalization of the Meta-DAG alongside other various DAG learning methods in accordance with one or more embodiments described herein.

In plot 802, average structural Hamming distance (SHD) s versus the training iterations are plotted. In plot 804, training objective values of the DAG learning models versus the training iterations are plotted. As shown in plot 802 and plot 804, Meta-DAG algorithms can obtain the lowest SHD compared to other methods, especially when d is large and can achieve approximately half of the SHDs of the NOTEARS methods. Meta-DAG-FO has a similar performance to Meta-DAG, although slightly lags behind in training but performs better at testing. Such observed generalization performance further illustrates that the Meta-DAG-FO is a practically efficient approximation of Meta-DAG.

For simplicity of explanation, the computer-implemented and non-computer-implemented methodologies provided herein are depicted and/or described as a series of acts. It is to be understood that the subject innovation is not limited by the acts illustrated and/or by the order of acts, for example acts can occur in one or more orders and/or concurrently, and with other acts not presented and described herein. Furthermore, not all illustrated acts can be utilized to implement the computer-implemented and non-computer-implemented methodologies in accordance with the described subject matter. Additionally, the computer-implemented methodologies described hereinafter and throughout this specification are capable of being stored on an article of manufacture to enable transporting and transferring the computer-implemented methodologies to computers. The term article of manufacture, as used herein, is intended to encompass a computer program accessible from any computer-readable device or storage media.

The systems and/or devices have been (and/or will be further) described herein with respect to interaction between one or more components. Such systems and/or components can include those components or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity, but known by those of skill in the art.

One or more embodiments described herein can employ hardware and/or software to solve problems that are highly technical, that are not abstract, and that cannot be performed as a set of mental acts by a human. For example, a human, or even thousands of humans, cannot efficiently, accurately and/or effectively perform meta causal learning over multiple acyclic graphs, as the one or more embodiments described herein can enable this process. And, neither can the human mind nor a human with pen and paper perform meta causal learning over multiple acyclic graphs, as conducted by one or more embodiments described herein.

FIG. 9 illustrates a block diagram of an example, non-limiting, operating environment in which one or more embodiments described herein can be facilitated. FIG. 9 and the following discussion are intended to provide a general description of a suitable operating environment 900 in which one or more embodiments described herein at FIGS. 1-8 can be implemented.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 contains an example of an environment for the execution of at least some of the computer code involved in performing the inventive methods, such as bilevel primal dual code 945. In addition to block 945, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and block 945, as identified above), peripheral device set 914 (including user interface (UI), device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”).

These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in block 945 in persistent storage 913.

COMMUNICATION FABRIC 911 is the signal conduction paths that allow the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, the volatile memory is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface type operating systems that employ a kernel. The code included in block 945 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing very large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901), and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The embodiments described herein can be directed to one or more of a system, a method, an apparatus and/or a computer program product at any possible technical detail level of integration. The computer program product can include a computer readable storage medium (or media) having computer readable program instructions thereon for causing a processor to carry out aspects of the one or more embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the one or more embodiments described herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In one or more embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of the one or more embodiments described herein.

Aspects of the one or more embodiments described herein are described with reference to flowchart illustrations and/or block diagrams of methods, apparatus (systems), and computer program products according to one or more embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality and/or operation of possible implementations of systems, computer-implementable methods and/or computer program products according to one or more embodiments described herein. In this regard, each block in the flowchart or block diagrams can represent a module, segment and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that the one or more embodiments herein also can be implemented at least partially in parallel with one or more other program modules. Generally, program modules include routines, programs, components and/or data structures that perform particular tasks and/or implement particular abstract data types. Moreover, the aforedescribed computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the one or more embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the one or more embodiments, but one of ordinary skill in the art can recognize that many further combinations and/or permutations of the one or more embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer-executable components stored in a non-transitory computer-readable memory, the computer-executable components comprising:
a data gathering component that collects datasets from a plurality of different environments or domains; and
a decomposition component that acts on the collected datasets to perform structured decomposition on multiple directed acyclic graphs (DAG) into a shared DAG with private DAGs for each environment or domain to generalize DAG learning.

2. The system of claim 1, wherein the system further comprises an analysis component that performs local task adaptation by using classical gradient descent over domain-specific data.

3. The system of claim 2, wherein the analysis component updates the shared DAG by combining private DAG weights learned from lower-level processes.

4. The system of claim 1, wherein the analysis component minimizes a score function and applies an augmented Lagrangian method to enforce DAG structure on the shared DAG weight matrix.

5. The system of claim 1, wherein the shared DAG is learned using validation data samples and the private DAGs are learned from domain-specific data samples.

6. The system of claim 1, wherein the shared DAG characterizes causal relationships among factors across a subset of the environments and domains and, wherein the private DAGs quantify corresponding strengths of the factors.

7. The system of claim 3, wherein the analysis component computes gradients of loss functions and selects corresponding step sizes to formalize discovery of a shared DAG weight matrix and the private DAGs' weight matrices.

8. The system of claim 1, wherein the analysis component uses a loss function with a validation dataset and a loss function with a training dataset to rectify discrepancies between a subset of the datasets.

9. The system of claim 1, wherein the analysis component imposes a DAG constraint to enable automatic retrieval of the DAGs.

10. The system of claim 1, wherein the analysis component employs a self-supervised structural equation model to enable continuous optimization.

11. The system of claim 1, wherein the analysis component guarantees finding Karush-Kuhn-Tucker (KKT) points with theoretical convergence rates.

12. A computer-implemented method, comprising:
collecting datasets from a plurality of different environments or domains; and
acting on the collected datasets to perform structured decomposition on multiple directed acyclic graphs (DAG) into a shared DAG with private DAGs for each environment or domain to generalize DAG learning.

13. The computer-implemented method of claim 12, further comprising engaging an analysis component to perform local task adaptation by using classical gradient descent over domain-specific data.

14. The computer-implemented method of claim 13, further comprising engaging the analysis component to update the shared DAG by combining private DAG weights learned from lower-level processes.

15. The computer-implemented method of claim 12, further comprising imposing a DAG constraint to enable automatic retrieval of the DAGs.

16. The computer-implemented method of claim 12, further comprising engaging the analysis component to guarantee finding Karush-Kuhn-Tucker (KKT) points with theoretical convergence rates.

17. The computer-implemented method of claim 12, further comprising engaging the analysis component to minimize a score function and apply an augmented Lagrangian method to enforce DAG structure on the shared DAG weight matrix.

18. The computer-implemented method of claim 12, further comprising employing a self-supervised structural equation model to enable continuous optimization.

19. A computer program product comprising a non-transitory computer-readable memory having program instructions embodied therewith, the program instructions executable by a processor to cause the processor to:
use a data gathering component that collects datasets from a plurality of different environments or domains; and
use a decomposition component that acts on the collected datasets to perform structured decomposition on multiple directed acyclic graphs (DAG) into a shared DAG with private DAGs for each environment or domain to generalize DAG learning.

20. The computer program product of claim 19, wherein the program instructions are further executable to cause the processor to:
engage an analysis component to perform local task adaptation by using classical gradient descent over domain-specific data.
